(19) United States
(12) Patent Application Publication
(10) Pub. No.: US 2003/0000750 A1
(43) Pub. Date: Jan. 2, 2003

(54) Method for controlling the torque output of a starter

(76) Inventors: Achim Selbertz, Aachen (DE); Rainer Busch, Aachen (DE)

Correspondence Address: Carlos L. Hanze, Ford Global Technologies, Inc., One Parklane Boulevard, 600 East Parklane Towers, Dearborn, MI, 48126, US

(21) Appl. No.: 10/186,512

(22) Filed: Jul. 1, 2002

(30) Foreign Application Priority Data
Jun. 29, 2001 (EP) 01115871.4

(51) Int. Cl. B60K 6/02

(52) U.S. Cl. 180/65.2

(57) ABSTRACT

A method is provided for controlling the torque output of a starter, in particular a high-power starter generator during the starting process of an internal combustion engine, and a corresponding vehicle drive for carrying out the method. Since rotational speed sensors only provide a usable rotational speed signal after a delay, in a first phase of the starting operation a non fed-back control is formed which is replaced by fed-back regulation when usable rotation speed signals are present.

### BACKGROUND OF THE INVENTION

1. Field of the Invention

The invention relates to a method for controlling the torque output of a starter during the starting process of an internal combustion engine which is coupled to the starter. In addition, the invention relates to a vehicle drive having an internal combustion engine, a starter which is coupled to an internal combustion engine, and a regulator for controlling the torque output of the starter during the starting operation of the internal combustion engine.

2. Background Art

Motor vehicles with an internal combustion engine generally have a starter which is used to start the internal combustion engine. At present, starter motors are being developed which are used to bring an internal combustion engine from a stationary state to the idling speed of, for example, 800 rpm within a few milliseconds. Such electric machines are frequently combined with a generator function, for which reason they are also referred to as (integrated) starter generators (S/A).

Such starter generators are known for example, from U.S. Pat. No. 6,073,713 and U.S. Pat. No. 6,002,219. In addition, EP 0 903 492 A2 discloses a method for actuating a starter generator in which a regulator controls the torque which is output by the starter while the internal combustion engine is being started. Here, the coolant temperature of the internal combustion engine is monitored and when the engine is cooled a lower current output of the electric machine is predefined. The intention of this measure is to permit reaction to a changed behavior of an internal combustion engine in comparison to a warmed-up internal combustion engine.

The power of modern electric machines can be used to switch off the internal combustion engine even during short stationary times, for example in front of a traffic light, and as a result save fuel. This is because the rapid reaction of the starter permits rapid restarting of the internal combustion engine so that, as it were, delay-free moving-off can take place. The torque which is output to the internal combustion engine by the starter during the starting process is controlled here as a function of specific operating parameters in accordance with a predetermined torque profile in order to avoid damage and to ensure rapid and comfortable starting of the internal combustion engine. Such regulation of the torque output of the starter usually takes place with feedback by means of a measurement of the rotational speed of the internal combustion engine which is reached. However, there is the problem here that the circuits used in practice for acquiring the rotational speed can detect the rotational speed of the engine only above a certain rotational speed threshold and with a certain time delay. This time delay arises, inter alia, as a result of the acquisition of the raw data, the subsequent signal filtering and transmission delays. All the influencing variables together can lead to a rotational speed acquisition process in which the first usable rotational spped signal is available only very late. Typically, up to 70% of the aimed-at urban speed may have been reached before the first signals are present.

### SUMMARY OF THE INVENTION

Against this background, an advantage of the present invention is to make available a method and a device for controlling the torque output of a starter by means of which an improved and more reliable starting behavior is ensured while retaining the known rotational speed measuring methods.

The method according to the invention for controlling the torque output of a starter, in particular a starter of the high-power type of a starter generator while an internal combustion engine which is coupled to the starter is being started, is based firstly on the fact that rotational speed sensors sense the rotational speed of the internal combustion engine. In the method, switching over occurs from a non fed-back control, which is carried out initially, of the torque output in which the rotational speed signal is not taken into account to a fed-back regulation of the torque output in which the rotational speed signaled by the rotational speed sensors is taken into account, as a function of at least one engine operating parameter, for example, of the rotational speed of the internal combustion engine which is reached and which is signaled by the rotational speed sensors.

In contrast to the known methods, the method explained thus does not continuously operate with fed-back regulation during the starting process. Instead, such regulation is firstly preceded by a phase with non fed-back control. This control phase extends at least to the time period in which a usable rotational signal has still not been made available by the rotational speed sensors. Instead of operating in this time period with the rotational speed signal, as is known in conventional fed-back regulation systems, in the method according to the invention there is no recourse to the rotational speed signal and instead a non fed-back control is performed. As a result, an improved starting performance of the starter can be achieved than with a fed-back regulation with possibly faulty sensor inputs. As soon as usable signals are supplied by the rotational speed sensors, it is possible to switch to the fed-back regulation whose satisfactory functioning is then ensured.

Preferably, the non fed-back control outputs purely time-dependent actuation signals to the starter. This means that the actuation signals are stored as time sequences in the control and their profile depends neither on the rotational speed nor other variables apart from time. The control profiles that are optimum for a respective vehicle drive can be acquired by a person skilled in the art by means of theoretical calculations or by using simple trials.

Fed-back regulations in the second phase of the starting process preferably takes place as a function of a fault signal which is defined as the difference between a predefined, desired rotational speed profile and the measured rotational speed. Because the measured rotational speed in the second phase of the starting process is reliably made available by the rotational speed sensors, the regulation can minimize the aforesaid fault signal with the result that the rotational speed of the internal combustion engine follows the predefined speed profile as well as possible.

A switching over from the non fed-back control to the fed-back regulation is advantageously performed when a predefined rotational speed is reached. The rotational speed signals of the rotational speed sensors are used here to monitor when this rotational speed is reached. It is necessary to ensure here that this rotational speed signal is not used until it has reached a stable and reliable value.

However, alternatively, other engine operating parameters can also be used for initiating the switching-over process, it being possible to use, for example, the time which is passed since the starter started or a signal of the torque sensors relating to the validity of the acquired torque signals etc. as engine operating parameters.

The transition between a non fed-back and fed-back operation can be configured by an attenuation term in the feedback regulator in such a way that excessively fast regulating jumps or overshoots are avoided.

The invention also relates to a vehicle drive which includes an internal combustion engine, a starter coupled to the internal combustion engine, a regulator for controlling the torque output of the starter during the starting process of the internal combustion engine and at least one rotational speed sensor which is coupled to the regulator and has the purpose of sensing the rotational speed of the internal combustion engine. The aforesaid regulator is designed here in such a way that it can carry out a method of the type explained above. This means that the regulator is functionally composed of two modules, one of which performs a non fed-back control during the first phase of the starting process and the second performs a fed-back regulation during the subsequent second phase of the starting process. The regulator can also be configured in such a way that the preferred embodiments of the explained method are implemented.

The starter of the vehicle drive according to the invention is preferably an integrated starter generator. Such a starter generator has considerable advantages owing to its power and permits fuel-saving operation of the vehicle. However, at the same time with such an electric machine it is necessary to control the torque output during the starting process as precisely as possible in order to prevent damage.

### BRIEF DESCRIPTION OF THE DRAWINGS

The invention is explained in more detail below by way of example with reference to the figures, of which:

FIG. 1 shows a schematic view of the components of a vehicle drive according to the invention; and

FIG. 2 shows a schematic view of the rotational speed profile during the starting process.

### DETAILED DESCRIPTION OF THE PREFERRED EMBODIMENTS

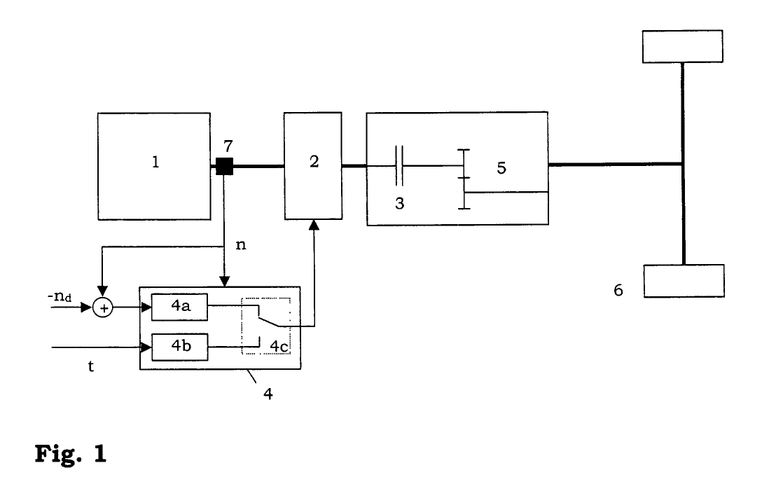

The vehicle drive illustrated in FIG. 1 contains an internal combustion engine 1 which drives an output shaft. An electric machine 2 in the form of a starter generator, which can be used either as a motor or as a generator, is arranged on the output shaft. The output shaft of the machine 2 is coupled via a clutch 3 to a transmission 5 by means of which various transmission ratios can be set. At the output end of the transmission 5, the drive torque is passed on to the wheels 6 of the vehicle. During the starting process of the internal combustion engine 1, the clutch 3 is opened in order to disconnect the internal combustion engine and starter from the transmission 5.

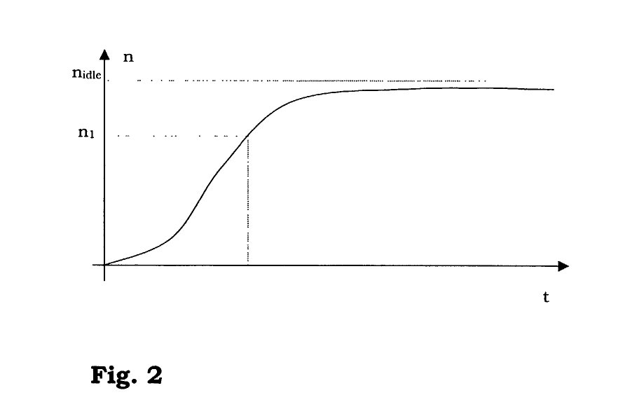

The starter generator 2 constitutes an electric machine of a modern type which is so powerful that the internal combustion engine 1 can be started within milliseconds. In order to avoid damage occurring in the process and disadvantageous behavior, the starter 2 is controlled by a regulator 4. From rotational speed sensors 7 arranged on the internal combustion engine 1, the regulator 4 receives a rotational speed signal which indicates the current rotational speed n of the internal combustion engine 1. It is to be noted here that when the internal combustion engine 1 is started, a usable rotational speed signal is made available by the rotational speed sensor 7 only with a very long delay owing to technical effects. This situation is illustrated in FIG. 2. FIG. 2 shows a typical profile of the rotational speed n (vertical axis) over time t (horizontal axis) during a starting process. It is apparent here that the first usable rotational speed signal n₁ is not available until the rotational speed has already reached approximately 70% of its maximum value, i.e. the idling speed n_{idle} There is therefore no usable rotational speed signal available to the regulator 4 over the greater part of the starting process.

Whereas in conventional regulators, fed-back regulation of the torque ouput of the machine 2 takes place in spite of the above, the regulator 4 according to the invention contains three different modules for performing the regulating function. The first module 4a corresponds to a fed-back regulation which receives, as input signal, a fault signal which is defined as the difference between the measured rotational speed n and a set point rotational speed n_{d}. However, in addition a module 4b for carrying out non fed-back control is also provided, the output signal of said control depending solely on the time t. The switching between the two aforesaid modules 4a, 4b is performed by a selection module 4c which passes on the actuation signal of the non fed-back control b to the machine 2 in the first phase of the starting process and the electronic signal of the fed-back regulator 4a to the machine 2 in the subsequent phase of the starting process. The switching module 4c monitors the rotational speed signal and performs the switching at the moment at which a first (usable) rotational speed signal is detected.

By means of the dual method of operation of the regulator 4, a better overall control of the electric machine 2 can be achived because it is not operated with faulty rotational speed signals in the first phase of the starting process.

Although the present invention has been described in connection with particular embodiments thereof, it is to be understood that various modifications, alterations and adaptations may be made by those skilled in the art without departing from the spirit and scope of the invention. It is intended that the invention be limited only by the appended claims.

What is claimed:

1. A method for controlling the torque output of a starter (2) coupled to an internal combustion engine, comprising:
sensing a rotational speed of the internal combustion engine; and
switching from an initial control of starter torque output which is not fed back with respect to the rotational speed of the internal combustion engine to a regulation of the starter torque output which is fed back with respect to the rotational speed of the internal combustion engine, as a function of at least one engine operating peramater.

2. The method according to claim 1, further comprising the step of outputting current-dependent actuation signals to the starter when the initial control is not fed back.

3. The method according to claim 1, wherein the fed-back regulation takes place as a function of an error signal composed of the difference between the measured speed and a predefined rotational speed profile.

4. The method according to claim 1, wherein said step of switching over occurs from the non fed-back control to the fed-back regulation when a predefined rotational speed is reached.

5. A vehicle drive comprising:
an internal combustion engine;
a starter coupled to the internal combustion engine;
a rotational speed sensor for sensing the rotational speed of the internal combustion engine; and
a regulator coupled to said starter and said speed sensor for controlling a torque output of the starter while the internal combustion engine is being started, said regulator having a first regulating module for a nonfed-back control of the torque output of said starter, a second regulating module for a fed-back regulation as a function of the rotational speed of said internal combustion engine, and a switching over unit for switching over the regulation from said first regulating module to said second regulating module as a function of at least one engine operating parameter during the starting process.

6. The vehicle drive according to claim 5, wherein the starter is an integrated starter generator.
